(19) United States
(12) Patent Application Publication
(10) Pub. No.: US 2003/0019912 A1
(43) Pub. Date: Jan. 30, 2003

(54) Outer cover shell and plate member soldering method

(76) Inventors: Dennis Shiau, Taichung Hsien (TW); Paul Hsiang, Tainan Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/901,654

(22) Filed: Jul. 11, 2001

(51) Int. Cl. B23K 1/06; B23K 1/20; B23K 31/02

(52) U.S. Cl. 228/110.1; 228/223

(57) ABSTRACT

An outer cover shell and plate member soldering method includes the steps of: (a) applying a predetermined thickness of soldering material to the border of the plate member, (b) pressing the outer cover shell on the plate member in the platform of a high-frequency heating machine, (c) lifting the platform to let the outer cover shell be coupled to the induction coil of the high-frequency heating machine, (d) driving the high-frequency heating machine to output an oscillating current, causing a high temperature to be produced around the border of the outer cover shell within the induction coil, (e) letting the soldering material be melted due to the thermal effect of the outer cover shell, so that the outer cover shell and the plate member are bonded together.

### BACKGROUND OF THE INVENTION

The present invention relates to a soldering method and, more particularly, to an outer cover shell and plate member soldering method. FIG. 1 illustrates an outer cover shell and plate member soldering method according to the prior art. According to this method, the bottom periphery of the outer cover shell 12 should be grounded well first and then covered on the plate member 14 with a certain thickness of soldering material 16 (which is normally of metal material) is applied to the contact area between the outer cover shell 12 and the plate member 14. At the same time, a heater 18 is operated to melt the soldering material 16 so as to produce a magnetic effect between the soldering material 16 and the outer cover shell 12, enabling the outer cover shell 12 to be bonded to the plate member 14. Because the soldering material 16 is applied to the outer surface of the contact area between the outer cover shell 12 and the plate member 14 and then a high temperature is applied to the soldering material 16 to melt the soldering material 16, it is difficult to evenly melt the soldering material 16 during the heating process. If the soldering material 16 is not evenly bonded to the outer cover shell 12 and the plate member 14, gaps or protruding portions will be produced in the bonding area between the outer cover shell 12 and the plate member 14. Further, because the soldering between the outer cover shell 12 and the plate member 14 is performed spot by spot or line by line, a long soldering time is required, and the soldering cost is relatively increased.

### SUMMARY OF THE INVENTION

The present invention has been accomplished under the circumstances in view. It is the main object of the present invention to provide an outer cover shell and plate member soldering method, which keeps the bonding area between the outer cover shell and the plate member in smooth so as to achieve complete bonding. It is another object of the present invention to provide an outer cover shell and plate member soldering method, which greatly shortens the soldering time to achieve a satisfactory economic effect. The outer cover shell and plate member soldering method invention of comprises the steps of: (a) applying a predetermined thickness of soldering material to the border of the plate member, (b) pressing the outer cover shell on the plate member in the platform of a high-frequency heating machine, (c) lifting the platform to let the outer cover shell be coupled to the induction coil of the high-frequency heating machine, (d) driving the high-frequency heating machine to output an oscillating current, causing a high temperature to be produced around the border of the outer cover shell within the induction coil, (e) letting the soldering material be melted due to the thermal effect of the outer cover shell, so that the outer cover shell and the plate member are bonded together.

### BRIEF DESCRIPTION OF THE DRAWINGS

FIG. 1 illustrates an outer cover shell and plate member soldering method according to the prior art.

FIG. 2 illustrates the main elements of the outer cover shell and plate member soldering method according to the present invention.

FIG. 3 illustrates the process of the outer cover shell and plate member soldering method according to the present invention.

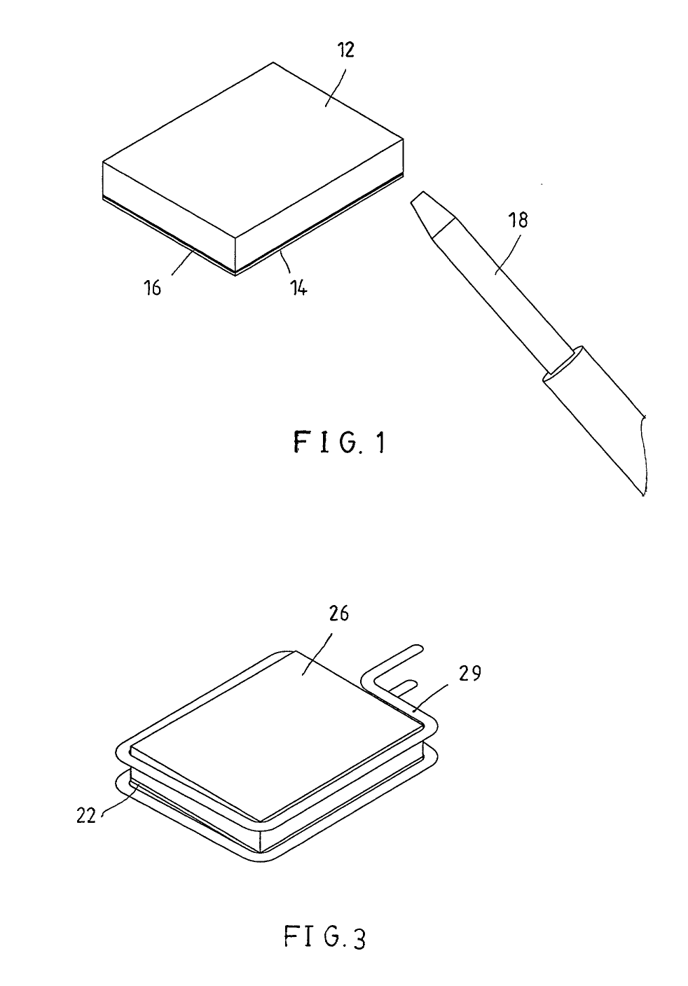

### DETAILED DESCRIPTION OF THE PREFERRED EMBODIMENT

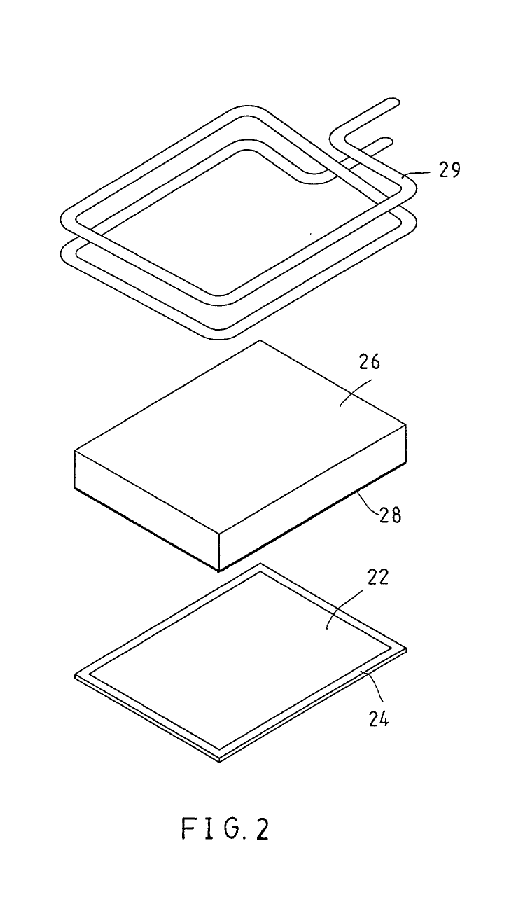

Referring to FIGS. 2 and 3, the outer cover shell and plate member soldering method of the present invention is to weld an outer cover shell 26 to a plate member 22. According to the present preferred embodiment of the present invention, the outer cover shell 26 is a metal member, and the plate member 22 is a printed circuit board. The method comprises the steps of:

Step a: applying a certain thickness of soldering material, for example, tin alloy 24 to the border of the plate member 22 evenly, and applying a certain thickness (for example, 1 mm thick) of soldering flux 28 to the bottom periphery of the outer cover shell 26;

Step b: putting the plate member 22 on the heating platform of a high-frequency heating machine, and then positioning the outer cover shell 26 on the plate member 22 by means of the application of a pressure;

Step c: lifting the heating platform to couple the outer cover shell 26 to an induction coil 29 of the high-frequency heating machine without letting the outer cover shell 26 touch the induction coil 29 and, keeping the center of the induction coil 29 in horizontal alignment with the elevation of the bonding face of the semi-finished product;

Step d: operating the high-frequency heating machine to output an oscillating current, causing a high temperature to be produced instantly around the border of the outer cover shell 26 within the induction coil 29 (at this time, the temperature of the top side of the outer cover shell 26 is maintained at the same level as prior to the processing procedure);

Step e: letting the tin alloy 24 be melted due to the thermal effect of the outer cover shell 26, so that the outer cover shell 26 and the plate member 22 are completely bonded together being a magnetic effect when the temperature reached a certain level.

In the aforesaid processing procedure, the shape, size and number of turns of the induction coil; the material of the outer cover shells the heating areas and the coupling position during inductions all these factors affect the heating effect or the actual output power of the heating machine. The invention adopts a double turn induction coil, and the coupling gap between the induction coil and the heating area is preferably within 1˜10 mm.

Further, different shape of magnetic conductor means may be used to reinforce the power output of the heating machine in case the shape of the outer cover shell does not fit planar heating in the induction coils or the material under heating is not a magnetic material.

Because the invention uses an induction coil to produce a high temperature instantly around the border of the outer cover shell to melt the soldering material at the plate member by means of the thermal effect of the outer cover shell, the soldering procedure is simplified and the soldering time is greatly shortened. Furthermore, the processed surface of the finished product is maintained smooth without gap or protruding portion. Because the induction coil is suspending around the border area of the outer cover shell, the temperature of the top side of the outer cover shell is maintained at the same level prior to the processing procedure during heating. Therefore, the invention is safe during the application, and the operator will not be injured when touching the top sidewall of the outer cover shell accidentally during heating.

A prototype of outer cover shell and plate member soldering method has been constructed with the features of FIGS. 2˜3. The outer cover shell and plate member soldering method functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An outer cover shell and plate member soldering method adapted to solder an outer cover shell to a plate member, comprising the steps of:
i) applying a predetermined thickness of soldering material to the border of said plate member;
ii) pressing said outer cover shell on said plate member to form a semi-finished product, and then coupling said semi-finished product to the induction coil of a high-frequency heating machine;
iii) operating said high-frequency heating machine to output an oscillating current, causing a high temperature to be produced around the border of said outer cover shell within said induction coil; and
iv) letting said soldering material be melted due to the thermal effect of said outer cover shell, so that said outer cover shell and said plate member are bonded together due to a magnetic effect between said outer cover shell and said plate material.

2. The outer cover shell and plate member soldering method of claim 1 further comprising the sub-step of applying a soldering flux to the bottom edge of the periphery of said outer cover shell for bonding to the soldering material at said plate member before step ii).

3. The outer cover shell and plate member soldering method of claim 1 wherein said induction coil is a double-turn induction coil.

4. The outer cover shell and plate member soldering method of claim 1 wherein the elevation of the center of said induction coil is same as the bonding face of said semi-finished product between said outer cover shell and said plate member.

5. The outer cover shell and plate member soldering method of claim 1 wherein said outer cover shell does not touch said induction coil when heating.

6. The outer cover shell and plate member soldering method of claim 1 wherein the coupling gap between said induction coil and the heating area of said semi-finished product is within 1˜10 mm.
